(19) United States
(12) Patent Application Publication
(10) Pub. No.: US 2007/0216923 A1
(43) Pub. Date: Sep. 20, 2007

(54) Image processing device

(75) Inventor: Kunihiko Tanaka, Osaka (JP)

Correspondence Address: GLOBAL IP COUNSELORS, LLP, 1233 20TH STREET, NW, SUITE 700, WASHINGTON, DC, 20036-2680, US

(73) Assignee: KYOCERA MITA CORPORATION, Osaka (JP)

(21) Appl. No.: 11/723,052

(22) Filed: Mar. 16, 2007

(30) Foreign Application Priority Data
Mar. 16, 2006 (JP) JP 2006-072359

(51) Int. Cl. G06F 15/00

(52) U.S. Cl. 358/1.9

(57) ABSTRACT

An image processing device 100 has a reading unit 2, a density measuring unit 81, and an extraction unit 82. The reading unit reads a plurality of samples 9. The density measuring unit 81 measures the density of the background image of the plurality of samples 9 having been read by the reading unit 2 and the density of the latent images included in the plurality of samples 9. The extraction unit 82 extracts combinations of background image and latent image. The background image has a density being equal to or less than a first predetermined value. The latent image has a density difference from the background images having a density equal to or less than the first predetermined value. The latent image has a density being equal to or less than a second predetermined value.

### CROSS-REFERENCE TO RELATED APPLICATIONS

This application claims priority to Japanese Patent Application No. 2006-072359 filed on Mar. 16, 2006. The entire disclosure of Japanese Patent Application No. 2006-072359 is hereby incorporated herein by reference.

### BACKGROUND OF THE INVENTION

1. Field of the Invention

The present invention generally relates to an image processing device. More specifically, the present invention relates to an image processing device used in image forming devices that generates ground tint images that includes latent images and background images.

2. Background Information

Some image processing devices generate ground tint images. Here ground tint patterns include both background images and latent images. Latent images are extremely difficult to see because of the background images, but when copied in a photocopier only the latent image is copied. Image processing devices that generate ground tint patterns include image processing devices in which a user selects from a plurality of samples that are created each provided with a plurality of latent image patches in a background image (see Japanese Patent Application Laid-open No. 2005-94327).

In the image processing device disclosed in the above document, it is necessary for a user to compare the density of the latent images and background images included in the samples, and determine the ideal combination. Since background images and the latent images whose densities are close are placed side by side, it is difficult to select the ideal combination. If a background image whose density is too high is selected there is a possibility that the background image will be printed when copying. Also, if a background image whose density is too low and a latent image whose density is too high are selected, it may be possible to distinguish the latent image from the background image at the stage of the original copy of the ground tint image. In these cases the ground tint function of the ground tint pattern cannot be sufficiently achieved.

In view of the above, it will be apparent to those skilled in the art from this disclosure that there exists a need for an improved image processing device. This invention addresses this need in the art as well as other needs, which will become apparent to those skilled in the art from this disclosure.

### SUMMARY OF THE INVENTION

It is an object of the present invention to be able to obtain reliably a ground tint pattern that includes a background image that is not reproduced when copying, and for which it is difficult to distinguish the background image and the latent image.

An image processing device according to a first aspect of the present invention is an image processing device used in an image forming device able to generate ground tint images that include latent images and background images. The image processing device has a sample reading unit, a density measuring unit, and an extraction unit. The sample reading unit reads a plurality of samples in which each sample includes a background image with a predetermined density and a plurality of latent images with different densities, and each sample is output with a different background image density. The density measuring unit measures the density of the background image of the plurality of samples that has been read by the sample reading unit, and the density of the latent images included in the plurality of samples. The extraction unit extracts combinations of background images, for which the density is equal to or less than a first predetermined value, and latent images for which the density difference from the background images whose density is equal to or less than the first predetermined value is equal to or less than a second predetermined value.

In this image processing device, sample image data for samples of ground tint images are read by the sample reading unit, and the density of the background images and latent images is measured by the density measuring unit. Then the extraction unit extracts combinations of background images, for which the density is equal to or less than the first predetermined value, and latent images for which the density difference from the background images whose density is equal to or less than the first predetermined value is equal to or less than the second predetermined value.

Here, ground tint patterns are extracted having background images and latent images that are difficult to distinguish, and background images that are not copied when photocopying. Therefore, the time required to select combinations that are capable of displaying the ground tint function sufficiently can be reduced.

An image processing device according to a second aspect of the present invention is the image processing device according to the first aspect, further including a notification unit that notifies the combinations of background image and latent image extracted by the extraction unit, so that the operator can determine the ideal combination from the combinations of background image and latent image extracted by the extraction unit.

Here, the operator can determine the ideal combination from among the combinations of background image and latent image extracted by the extraction unit, so the freedom of selection of the operator is increased.

An image processing device according to a third aspect of the present invention is the image processing device according to the second aspect, wherein the notification unit further notifies the combination of background image and latent image with the smallest density difference from among the combinations of background image and latent image extracted by the extraction unit.

Here, the combination for which the difference in density of the background image and latent image is the smallest is also notified, so the ideal combination can be easily selected.

An image processing device according to a fourth aspect of the present invention is the image processing device according to the first aspect, further including a combination selection unit that automatically selects the combination of background image and latent image with the smallest density difference from among the combinations of background image and latent image extracted by the extraction unit.

Here, the combination for which the difference in density of the background image and latent image is the smallest is automatically selected, so the user can save time in selecting the combination.

An image forming device according to a fifth aspect of the present invention has a display panel and an image processing device. The display panel is arranged on an outer frame. The image processing device is used in an image forming device that generates ground tint images that include latent images and background images. The image processing device has a sample reading unit, a density measuring unit, an extraction unit, and a notification unit. The sample reading unit reads a plurality of samples in which each sample includes a background image with a predetermined density and a plurality of latent images with different densities, and each sample is output with a different background image density. The density measuring unit measures the density of the background image of the plurality of samples that has been read by the sample reading unit, and the density of the latent images included in the plurality of samples. The extraction unit extracts combinations of background images, for which the density is equal to or less than a first predetermined value, and latent images for which the density difference from the background images whose density is equal to or less than the first predetermined value is equal to or less than a second predetermined value. The notification unit notifies the combinations of background images and latent image extracted by the extraction unit to determine the ideal combination from the combinations of background image and latent image extracted by the extraction unit. Further, the notification unit displays the combinations of background image and latent image extracted by the extraction unit in the display panel.

An image forming device according to a sixth aspect has a reading unit, an image forming unit, a fixing unit, a discharge unit, a sheet housing unit, a sheet transport unit, and an image processing device. The reading unit reads document image data. The image forming unit forms images based on the image data. The fixing unit fixes images formed on sheets in the image forming unit onto the sheets. The discharge unit discharges sheets on which images have been fixed. The sheet housing unit houses sheets to be supplied to the image forming unit. The sheet transport unit is capable of transporting sheets from the sheet housing unit to the image forming unit, the fixing unit, and the discharge unit in that order. The image processing device used in an image forming device is able to generate ground tint images that include latent images and background images. The image processing device has a sample reading unit, a density measuring unit, and an extraction unit. The sample reading unit reads a plurality of samples in which each sample includes a background image with a predetermined density and a plurality of latent images with different densities, and each sample is output with a different background image density. The density measuring unit measures the density of the background image of the plurality of samples that has been read by the sample reading unit, and the density of the latent images included in the plurality of samples. The extraction unit extracts combinations of background images, for which the density is equal to or less than a first predetermined value, and latent images for which the density difference from the background images whose density is equal to or less than the first predetermined value is equal to or less than a second predetermined value.

An image forming device according to a seventh aspect of the present invention is the image processing device according to the sixth aspect, wherein the image processing device has a notification unit that notifies the combinations of background image and latent image extracted by the extraction unit to determine the ideal combination from the combinations of background image and latent image extracted by the extraction unit.

According to the present invention it is possible to obtain reliably a ground tint pattern that includes a background image that is not reproduced when copying, and for which it is difficult to distinguish the background image and the latent image.

These and other objects, features, aspects, and advantages of the present invention will become apparent to those skilled in the art from the following detailed description, which, taken in conjunction with the annexed drawings, discloses a preferred embodiment of the present invention.

### BRIEF DESCRIPTION OF THE DRAWINGS

Referring now to the attached drawings which form a part of this original disclosure:

FIG. 1 is a schematic cross-sectional view of a multi-function printer according to a first preferred embodiment of the present invention;

FIG. 2 is a view of a block diagram of a display panel and an image processing device having a background image and latent image combination selection device of the multi-function printer;

FIG. 3 is a perspective view of the multi-function printer;

FIG. 4 is a view of a diagram showing a ground tint pattern sample;

FIG. 5 is a view of a flowchart showing the operation of extracting and selecting the combination of latent image and background image of the ground tint image; and

FIG. 6 is a view of a block diagram showing an image processing device having a combination selection device according to an alternate embodiment of the present invention.

### DETAILED DESCRIPTION OF THE PREFERRED EMBODIMENTS

Selected embodiments of the present invention will now be explained with reference to the drawings. It will be apparent to those skilled in the art from this disclosure that the following descriptions of the embodiments of the present invention are provided for illustration only and not for the purpose of limiting the invention as defined by the appended claims and their equivalents.

### 1. Configuration

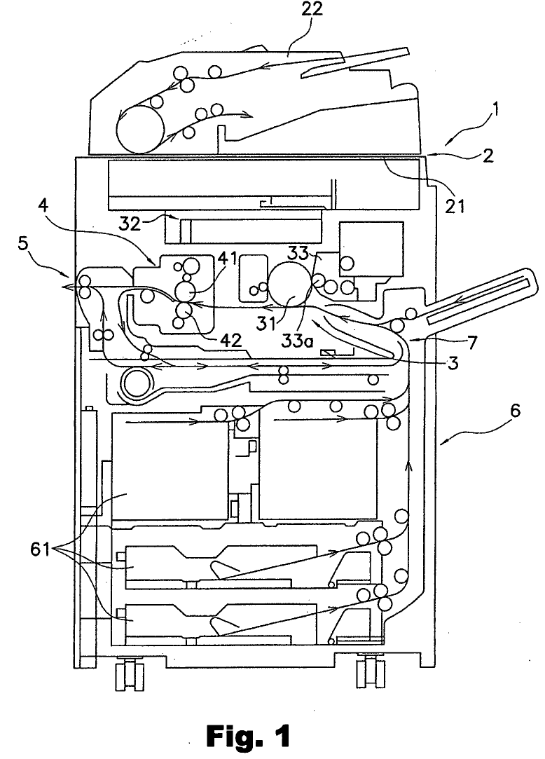

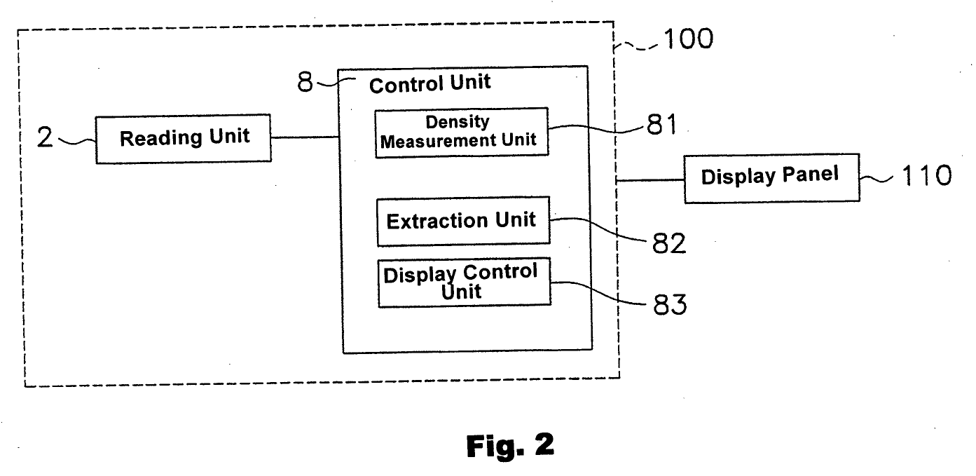

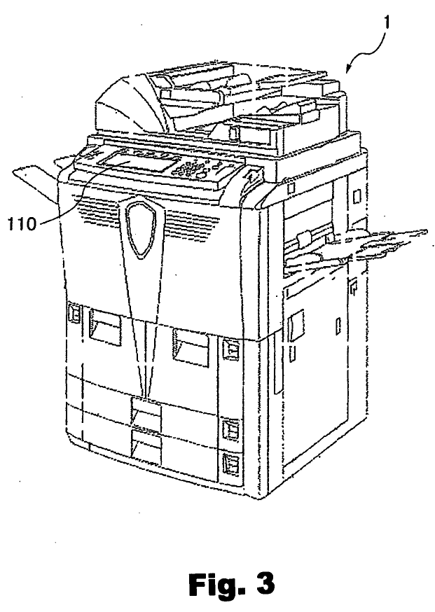

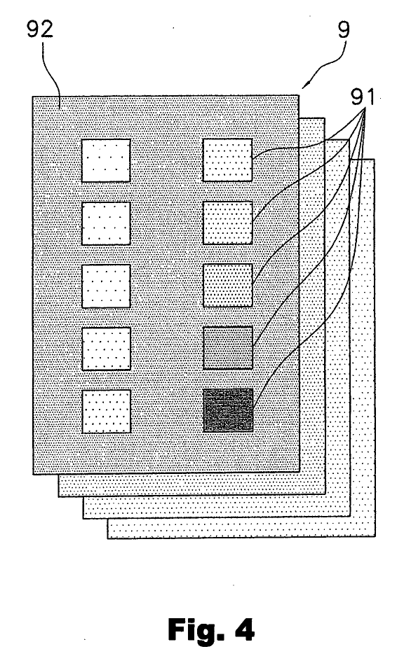

FIG. 1 shows a multi-function printer 1 that includes an image processing device 100 (see FIG. 2) according to a preferred embodiment of the present invention. FIG. 1 is an overall schematic view of the multi-function printer 1, with some components omitted for clarity and explanatory reasons. The multi-function printer 1 includes a reading unit 2, an image forming unit 3, a fixing unit 4, a discharge unit 5, a sheet housing unit 6, a sheet transport unit 7, and a display panel 110 as shown in FIGS. 2 and 3. Also, the multi-function printer 1 is preferably connected to an external computer. Image data for the images to be printed and image data of samples of ground tint pattern can be transmitted from the computer to the multi-function printer 1. Here, as shown in FIG. 4, a sample 9 of ground tint patterns preferably includes ten latent image patches 91 each of different density, and a background image 92 around the latent image patches 91. As seen in FIG. 2, the image processing device 100 includes a control unit 8 that is described later, and the reading unit 2.

Referring now to FIGS. 1 and 2, the reading unit 2 (sample reading device) reads samples 9 of ground tint pattern and image data of documents, and includes a contact glass 21, a cover 22, and a CCD sensor and an optical system that are not shown on the drawings. In the reading unit 2, documents to be read or ground tint pattern samples 9 are placed on the contact glass 21 then the cover 22 is closed. Then by a read command (by pressing a read key on a display panel 110 that is described later) the image data of the document surface facing towards the document glass 21 are read when copying documents, or the image data of the sample 9 of ground tint patterns when forming ground tint images are read.

The image forming unit 3 forms images on sheets, and includes a photosensitive drum 31, a laser unit 32, and a developing unit 33. The image forming unit 3 is disposed to the top of the multi-function printer 1. The photosensitive drum 31 is a cylindrical shaped member on the surface of which electrostatic latent images are formed based on image data read by the reading unit 2 or image data transmitted from the computer. The laser unit 32 is a member that irradiates the photosensitive drum 31 with laser light. The developing unit 33 supplies toner to the surface of the photosensitive drum 31, and is disposed adjacent to the photosensitive drum 31. The developing unit 33 houses toner in the interior thereof, and includes a developing roller 33a in opposition to the photosensitive drum 31. Toner is supplied to the surface of the photosensitive drum 31 by the developing roller 33a.

The fixing unit 4 is a member that fixes images formed on sheets by the image forming unit 3 to the sheets, and includes a heating roller 41 and a pressure roller 42. Also, the fixing unit 4 is disposed on the downstream side of the image forming unit 3 in the direction of transport of sheets. The heating roller 41 melts and fixes toner images formed on sheets by heating. The pressure roller 42 is disposed in opposition to the heating roller 41.

The discharge unit 5 discharges sheets that have been copied from within the multi-function printer 1 to the outside of the multi-function printer 1, and is disposed to the side of the multi-function printer 1.

The sheet housing unit 6 houses sheets that are supplied to the image forming unit 3, and includes a plurality of sheet supply cassettes 61. Also, the sheet housing unit 6 is disposed at the bottom of the multi-function printer 1. The plurality of sheet supply cassettes 61 can house different types of sheets (for example, A4, A3, B4, and so on).

The sheet transport unit 7 can transport sheets from the sheet housing unit 6 to the image forming unit 3, the fixing unit 4, and the discharge unit 5, in that order. Registration rollers and feed rollers are disposed in the sheet transport unit 7.

The display panel 110 is connected to the control unit 8, as shown in FIG. 2, and is provided on the external frame of the multi-function printer 1, as shown in FIG. 3. Also, the display panel 110 includes a plurality of keys to set printing conditions and to operate the multi-function printer 1. Also, when image data of n sheets of samples 9 of ground tint images are read by the reading unit 2, combinations of background image having a density equal to or less than a first predetermined value (the value of density for which the background density is not printed when copied in a photocopier), and latent images having a difference in density from the background image, whose density is equal to or less than the first predetermined value, that is equal to or less than a second predetermined value (the value of density difference for which the background image can be distinguished) are displayed. At this time, simultaneously the combination of background image and latent image whose difference in density is smallest is displayed in a format that the operator can recognize.

The multi-function printer 1 also includes a control unit 8. The control unit 8 functions as a density measurement unit 81, an extraction unit 82, and a display control unit 83 (notification unit) by executing a program on a CPU.

The density measurement unit 81 measures the density of background images and latent images of ground tint pattern samples 9.

The extraction unit 82 extracts from among a plurality of ground tint pattern samples 9 read by the reading unit 2 combinations of background image and latent images for which the density of the background image is equal to or less than the density that is not reproduced when copied in a photocopier or and the like. Further, the difference in density between the density of the background image and the density of the latent images is equal to or less than a predetermined value.

The display control unit 83 notifies the operator of the combinations of background image and latent image extracted by the extraction unit 82 in order that an operator can determine a suitable combination from among the combinations of background image and latent image extracted by the extraction unit 82. At this time, the display control unit 83 simultaneously notifies the operator of the combination for which the density difference between the background image and the latent image is the smallest from among the combinations of background image and latent image extracted by the extraction unit 82. Specifically, the display control unit 83 simultaneously notifies the operator by displaying the combinations of background image and latent image in the display panel 110.

### 2. Operation

First, the operation of the multi-function printer 1 when printing an image onto a sheet is explained.

When printing an image onto a sheet, first the image data are transmitted from an external computer, or the image data for a document are read by the reading unit 2. At this time, a sheet from the sheet housing unit 6 is transported to the image forming unit 3. Then, the image data are transmitted to the image forming unit 3, and the image is formed on the sheet by the image forming unit 3 based on the image data. The sheet on which the image has been formed is transported to the fixing unit 4, where the toner image is fixed to the sheet. The sheet on which the toner image was fixed by the fixing unit 4 is discharged from the discharge unit 5.

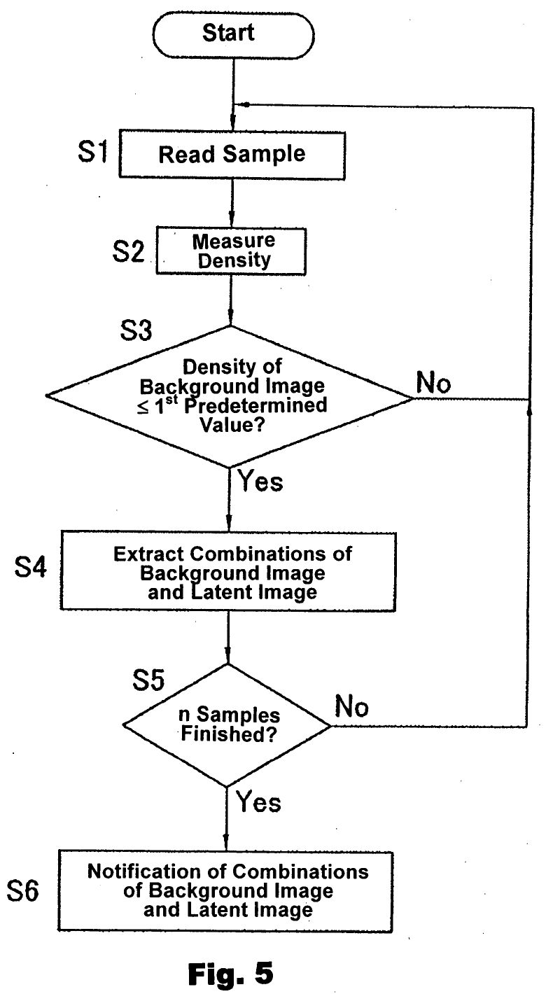

Next, the operations of extracting and selecting combinations of background image and latent image are explained. Here, FIG. 5 shows a flowchart showing the operation of extracting and the operation of selecting combinations of background image and latent image.

Image data of samples 9 of ground tint pattern are transmitted to the multi-function printer 1 from an external computer, and the multi-function printer 1 prints n sheets of samples 9 of ground tint pattern. Then image data for the first sheet of samples 9 of ground tint pattern are read by the reading unit 2 (Step S1). Then, the image density of the background image and the latent images of the samples 9 of the ground tint pattern is measured by the density measuring unit (S2). It is determined whether the density of the background image is equal to or less than a first predetermined value (S3). Specifically, it is determined whether the background density is a density that is not printed when copying in a photocopier. If the density of the background image is greater than the first predetermined value (NO at S3), the next ground tint sample 9 is read. If the density of the background image is equal to or less than the first predetermined value (NO at S3), the combinations of background image and latent image are extracted (S4). Specifically, combinations of background image and latent image for which the difference in density between the background image and latent image is equal to or less than the second predetermined value are extracted. Then, it is determined whether the n^{th} sample has been read (S5). Here, n is the number of ground tint pattern samples 9. If the n^{th} sample has not been completed (NO at S5), the next ground tint pattern sample 9 is read. If the nth sample has been completed (YES at S5), the extracted combinations of background image and latent image are notified to the operator by displaying in the display panel 110. At this time, the user is simultaneously notified of the combination of background image and latent image for which the difference in density is smallest by displaying in the display panel 110. The user selects one combination from among the combinations of background image and latent image displayed in the display panel 110, and the selected combination of ground tint pattern is printed.

Here, the background image is not printed when copied in a photocopier because the density of the background image is equal to or less than the first predetermined value. Also, since ground tint images for which the density difference between the background image and the latent image is small are extracted, it is possible to prevent the ground tint function from not functioning due to being able to distinguish the latent image from the background image. Furthermore, only ground tint images that can sufficiently achieve the ground tint function are displayed in the display panel 110. Also, an operator can select from their combinations using the display panel 110. Therefore the freedom of selection for the operator is increased. Also, the combination for which the density difference between the background image and the latent image is the smallest is displayed in the display panel 110, so it is easy to select the ideal combination.

### 3. Other Embodiments

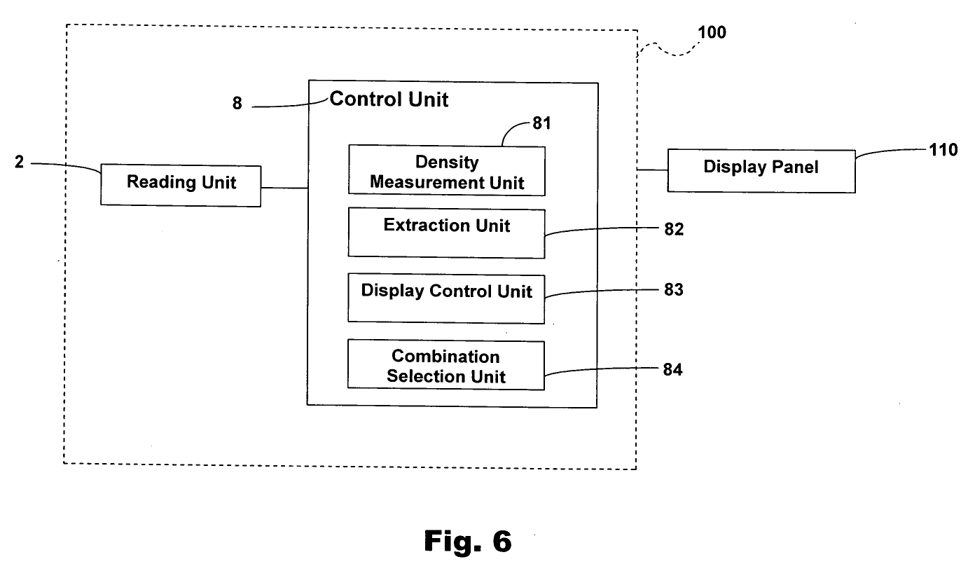

(a) In the embodiment described above, the combinations of background image and latent image extracted by the extraction unit are displayed in the display panel, and the operator selects the combination of background image and latent image. However, the present invention is not limited to this. A combination selection unit 84 is provided in the image processing device as shown in FIG. 6, and the combination for which the density difference between the background image and the latent image is the smallest may be automatically selected (selection means). In this case, the operator's selection time can be saved. Except for the combination selection unit 84, the other components are the same or substantially the same as those of the first embodiment.

(b) In the embodiment as described above, the multi-function printer 1 was explained, however the present invention is not limited to this, and a computer and scanner and so on may be used.

(c) In the embodiment as described above, the operator is notified by displaying the combinations in the display panel 110. However, the present invention is not limited to this, and the combinations may be notified to the operator by voice or the like.

The term “configured” as used herein to describe a component, section or part of a device includes hardware and/or software that is constructed and/or programmed to carry out the desired function.

Moreover, terms that are expressed as “means-plus function” in the claims should include any structure that can be utilized to carry out the function of that part of the present invention.

### General Interpretation of Terms

In understanding the scope of the present invention, the term “configured” as used herein to describe a component, section or part of a device includes hardware and/or software that is constructed and/or programmed to carry out the desired function. In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including,” “having,” and their derivatives. Also, the terms “part,” “section,” “portion,” “member,” or “element” when used in the singular can have the dual meaning of a single part or a plurality of parts. As used herein to describe the present invention, the following directional terms “forward, rearward, above, downward, vertical, horizontal, below, and transverse” as well as any other similar directional terms refer to those directions of an image processing device equipped with the present invention. Accordingly, these terms, as utilized to describe the present invention should be interpreted relative to an image processing device equipped with the present invention as used in the normal riding position. Finally, terms of degree such as “substantially,” “about,” and “approximately” as used herein mean a reasonable amount of deviation of the modified term such that the end result is not significantly changed. For example, these terms can be construed as including a deviation of at least ±5% of the modified term if this deviation would not negate the meaning of the word it modifies.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents.

What is claimed is:

1. An image processing device of an image forming device configured to generate ground tint images including latent images and background images, comprising:
a sample reading unit being configured to read a plurality of samples, each of the plurality of samples including a background image with a predetermined density and a plurality of latent images with different densities, and each of the plurality of samples being output with a different background image density;
a density measuring unit being configured to measure the density of the background image of the plurality of samples having been read by the sample reading unit, and the density of the latent images included in the plurality of samples; and
an extraction unit being configured to extract combinations of background image and latent image, the background image having a density being equal to or less than a first predetermined value, the latent image having a density difference from the background images having a density equal to or less than the first predetermined value, and the latent image having a density being equal to or less than a second predetermined value.

2. The image processing device according to claim 1, further comprising a notification unit that notifies the combinations of background image and latent image extracted by the extraction unit to determine the ideal combination from the combinations of background image and latent image extracted by the extraction unit.

3. The image processing device according to claim 2, wherein the notification unit further notifies the combination of background image and latent image with the smallest density difference from among the combinations of background image and latent image extracted by the extraction unit.

4. The image processing device according to claim 1, further comprising a combination selection unit that automatically selects the combination of background image and latent image with the smallest density difference from among the combinations of background image and latent image extracted by the extraction unit.

5. An image forming device, comprising:
a display panel on an outer frame; and
an image processing device being connected to the display panel, and configured to generate ground tint images including latent images and background images, the image processing device having
a sample reading unit being configured to read a plurality of samples, each of the plurality of samples including a background image with a predetermined density and a plurality of latent images with different densities, and each of the plurality of samples being output with a different background image density,
a density measuring unit being configured to measure the density of the background image of the plurality of samples having been read by the sample reading unit, and the density of the latent images included in the plurality of samples,
an extraction unit being configured to extract combinations of background image and latent image, the background image having a density being equal to or less than a first predetermined value, the latent image having a density difference from the background images having a density equal to or less than the first predetermined value, and the latent image having a density being equal to or less than a second predetermined value, and
a notification unit being configured to notify the combinations of background image and latent image extracted by the extraction unit to determine the ideal combination from the combinations of background image and latent image extracted by the extraction unit, the notification unit displaying the combinations of background image and latent image extracted by the extraction unit in the display panel.

6. An image forming device, comprising:
a reading unit being configured to read document image data;
an image forming being configured to form images based on the image data;
a fixing unit being configured to fix images formed on sheets in the image forming unit onto the sheets;
a discharge unit being configured to discharge sheets having images fixed thereon;
a sheet housing unit being configured to house sheets to be supplied to the image forming unit;
a sheet transport unit being configured to transport sheets from the sheet housing unit to the image forming unit, the fixing unit, and the discharge unit in that order; and
an image processing device being configured to generate ground tint images including latent images and background images, having
a sample reading unit being configured to read a plurality of samples, each of the plurality of samples including a background image with a predetermined density and a plurality of latent images with different densities, and each of the plurality of samples being output with a different background image density,
a density measuring unit being configured to measure the density of the background image of the plurality of samples having been read by the sample reading unit, and the density of the latent images included in the plurality of samples, and
an extraction unit being configured to extract combinations of background image and latent image, the background image having a density being equal to or less than a first predetermined value, the latent image having a density difference from the background images having a density equal to or less than the first predetermined value, and the latent image having a density being equal to or less than a second predetermined value.

7. The image forming device according to claim 6, wherein the image processing device has a notification unit that notifies the combinations of background image and latent image extracted by the extraction unit to determine the ideal combination from the combinations of background image and latent image extracted by the extraction unit.
